(19) United States
(12) Patent Application Publication
(10) Pub. No.: US 2014/0067800 A1
(43) Pub. Date: Mar. 6, 2014

(54) SYSTEMS AND METHODS FOR ANALYZING AND PREDICTING AUTOMOTIVE DATA

(71) Applicant: Amit Sharma, Sterling, VA (US)

(72) Inventor: Amit Sharma, Sterling, VA (US)

(21) Appl. No.: 13/601,224

(22) Filed: Aug. 31, 2012

(51) Int. Cl. G06F 17/30

(52) U.S. Cl. 707/736; 707/E17.009

(57) ABSTRACT

Computerized systems distribute storage and analytical tasks between multiple storage devices and processors to analyze large amounts of automotive data. Reception of huge amounts of fine automotive data from large amounts of users and delivery of real-time and predictive analysis of the data can be handled across a distributed architecture. Configured storage devices can retain a universe of all reported/collected automotive data and advanced analytics can be performed on the data, before and after storage. The analyses can include real-time data extraction, batch-type complex predictive analysis, data management, machine learning on useful analytics, etc. The large and real-time data input may not interfere with analysis on the universe of accumulated data, permitting users and/or third-parties to readily access results of such analyses in real-time.

### BACKGROUND

Automotive conditions, including traffic data and individual car data, are known and available through conventional networks. For example, several services exist that report traffic conditions to mobile station users based on location, route, etc. Such systems may aggregate live data feed from municipal traffic monitors, eyewitness reports, automated vehicle volume sensors, current traffic conditions, GPS and navigation user density and movement, etc. Data can then be provided to users that reflects these conditions, and routing can be calculated based on these conditions. Data can be provided electronically to mobile station users while in or preparing for transit. Data in these types of services tend to include aggregate and live, incidental data that may be provided to users as is.

Other services exist that report individual automobile history and traffic incidents. For example, municipal accident databases may gather post-accident vehicle information and accident location and type from reporting officers and the judicial system. Such databases can be provided to automotive purchasers to understand any accident history of a particular vehicle. Data in these types of services tend to include only post-severe-event data points on single automobiles and/or reported accidents. Further, data in individual automotive history reports are not conventionally available in real time or to mobile station users but are instead available as post-hoc, developed and sometimes purchasable reports reporting data as is.

### SUMMARY

Example embodiments include computer systems that analyze automotive data using multiple networks and/or storage devices. One of the networks can receive the raw automotive data from users, and with optional formatting and addition of metadata regarding the data's context, pass it to another network. The receiving network may then accumulate a universal data set of the automotive data streaming in from the sending network on a larger database, such as a Big Data file system and analysis protocols. With properly-configured processing hardware, such as a high-efficiency distributed system architecture, the receiving network can strategically parse the incoming automotive data for real-time information that can instantaneously be sent back to the original network to supplement a database in the first network for user consumption. Incoming automotive data can also be saved on the larger database to amass a universal automotive data set for analysis by the processor.

These analyses using universal automotive data can be extensive and involve extremely large amounts of input without interfering with data collection and real-time analytical distribution. Once generated, large universal analytical reports can be incrementally updated with real-time analysis and/or shipped to a user-interfaced network for immediate consumption by users or third-parties. Example systems are useable with mobile stations that can readily report fine levels of automotive data, including vehicle descriptions, behavior, and locations, road conditions, traffic patterns, route information, etc. Generated analyses can use these large inputs to create real-time and/or predictive analysis. Further, the analyses can be generated in response to user inquiries and/or machine learning on available data. Example methods can work on example embodiment systems to receive, format, analyze, meta-analyze, selectively store or move, and/or provide reports with automotive data.

### BRIEF DESCRIPTIONS OF THE DRAWINGS

Example embodiments will become more apparent by describing, in detail, the attached drawings, wherein like elements are represented by like reference numerals, which are given by way of illustration only and thus do not limit the example embodiments herein.

FIG. 1 is an illustration of an example embodiment system.

FIG. 2 is an illustration of an example method.

FIG. 3 is an illustration of an example method.

### DETAILED DESCRIPTION

This is a patent document, and general broad rules of construction should be applied when reading it. Everything described and shown in this document is an example of subject matter falling within the scope of the claims, appended below. Any specific structural and functional details disclosed herein are merely for purposes of describing how to make and use example embodiments. Several different embodiments not specifically disclosed herein may fall within the claim scope; as such, the claims may be embodied in many alternate forms and should not be construed as limited to only example embodiments set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that when an element is referred to as being “connected,” “coupled,” “mated,” “attached,” or “fixed” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.). Similarly, a term such as “communicatively connected” includes all variations of information exchange routes between two devices, including intermediary devices, networks, etc., connected wirelessly or not.

As used herein, the singular forms “a”, “an” and “the” and the plural form “indicia” are intended to include both the singular and plural forms, unless the language explicitly indicates otherwise. It will be further understood that the terms “comprises,” “comprising,” “includes,” and/or “including,” when used herein, specify the presence of stated features, integers, steps, operations, elements, and/or components, but do not themselves preclude the presence or addition of one or more other features, integers, steps, operations, elements, components, and/or groups thereof.

It should also be noted that the structures and operations discussed below may occur out of the order described and/or noted in the figures. For example, two operations and/or figures shown in succession may in fact be executed concurrently or may sometimes be executed in the reverse order, depending upon the functionality/acts involved. Similarly, individual operations within example methods described below may be executed repetitively, individually or sequentially, so as to provide looping or other series of operations aside from the single operations described below. It should be presumed that any embodiment having features and functionality described below, in any workable combination, falls within the scope of example embodiments.

The inventor has recognized that individualized automotive data can be gathered and/or analyzed together with aggregate automotive data, both in real-time and from historical data, to make useful correlations and yield improved user data on traffic patterns, vehicle behavioral prediction, road conditions, vehicle demographics, and vehicular/location risk or accident probabilities. Although the combination of individual automotive data, such as the behavior of an individual car or an eyewitness report of a road condition, with aggregate automotive data, such as historic traffic patterns at given geographic locations may present a huge data set with which to work, strategic data handling and analysis of such near-universal data sets may provide relatively more compact and useable results for individual consumption in real or near-real time, if desired. Similarly, the inventor has recognized that individualized automotive data can be gathered and compiled in real-time and at very fine levels of information, such as from individual reports from mobile users, and, while this may represent a tremendous amount of data, can be usefully analyzed along with gathered historical or aggregate information using strategic data handling and analysis to provide fast, useable results from a huge and varied data set.

The present invention is a system that analyzes automotive data using strategic data management between multiple storage regimes. Computer processor use of, and user access to, different file systems having different information permits useful analyses, such as predictive or real-time analyses, on universal automotive data from several sources along with real-time delivery of analyses. The present invention is also computerized methods of performing automotive analysis and strategic data processing for huge, universal automotive data sets with predictive or real-time application. One or more example embodiment and method of these inventions are described below in detail. It is understood that the example hardware configurations and actions with regard to data described below are merely options, and other options and arrangements are readily useable to practice the appended claims.

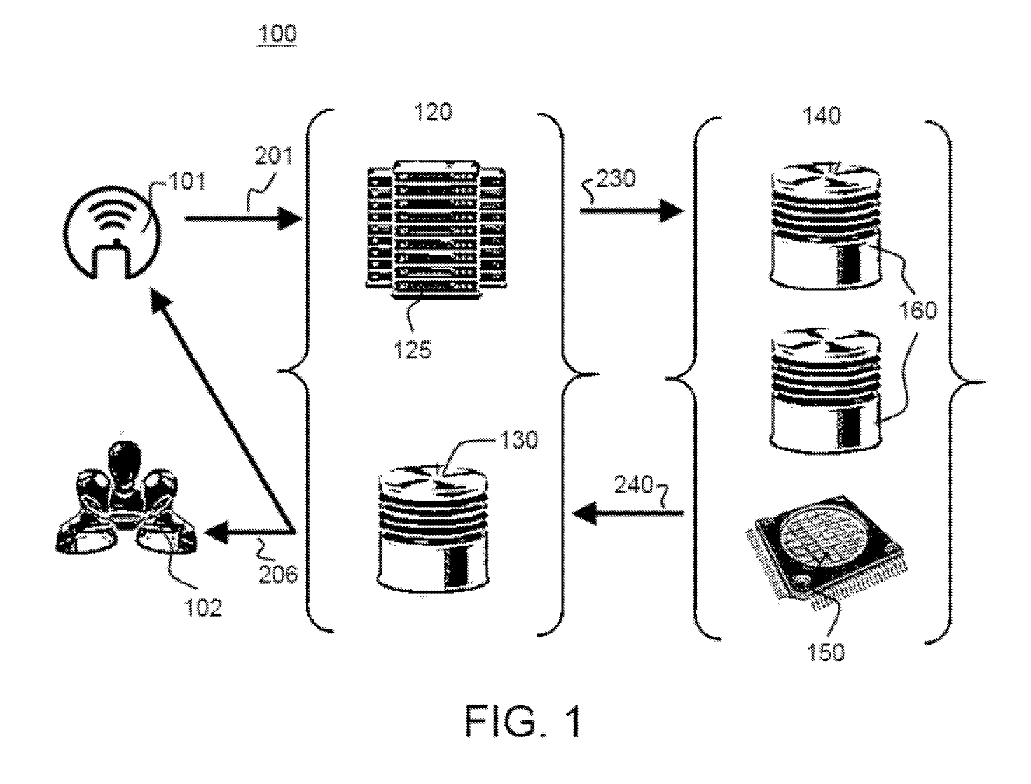

FIG. 1 is a diagram of an example embodiment automotive tracking and analysis system 100. As shown in FIG. 1, a user 101 is communicatively connected to an automotive information access network 120. User 101 can be any device capable of receiving and processing automotive information for user consumption. For example, user 101 can be a mobile station such as a cellular telephone connected to a communications network, or a computer connected to the Internet, or a GPS device connected to a GPS network, etc. As used herein, the term “mobile station” is defined as any non-human device capable of communicative connections, either directly or indirectly. For example, mobile devices useable in example methods and embodiments include cellular telephones, pagers, Global Positioning System devices, personal data assistants, personal computers, radios, walkie-talkies, remote controls, etc. Further, as used herein, “automotive data” and “automotive information” includes all data and inquiries, real-time or historical, raw, aggregate, formatted, compiled, or otherwise, relating to vehicles, locations, vehicle operators, road conditions, routing information, road environments, and any other road-based vehicular transportation information. User 101 can be directly connected to automotive information access network 120 or may connect through another network, such as the Internet.

Other users and/or community resources 102 can similarly be connected to automotive information access network 120, directly or via another communications network such as Internet 110. Community resources 102 can include any available information resource that may be serviced by, or drawn from network 120, including public traffic reports, vehicle information websites, government census and traffic fatality information, Internet-based maps, geographic markers, roadside networks, user communities, third-party data vendors, web services, feedback and review sites, etc.

Automotive information access network 120 is a system that retrieves, formats, sends, and receives automotive data to or from users 101, community resources 102, and/or any analytics engine 140. For example, automotive information access network 120 may include an Internet-based server 130 configured for rapid data intake and delivery among several users 101 and/or community resources 102 accessing network 120 over the Internet, including standard communications protocols such as TCP/IP. Such a server 130 may include conventional domain and/or security protocols for access and authentication as well as processing capacities to retrieve, deliver, and/or format automotive data for use within example embodiment system 1000. Or, for example, automotive information access network 120 may be an intranet lacking Internet protocols, and user 101 may be an internal intranet user. Access network 120 may include a server 125 with its own transient data storage capabilities to handle and persist user inquiries and data input, regardless of when or whether such data is assigned to an ultimate data storage type or compiled in an analysis. Similarly, access network 120 may include its own processors and routines to gather or solicit information useful in example system 100 from external sources such as community 102 and/or users 101.

Access network 120 includes an interactive database 130 that is useable for near real-time or real-time data and analysis delivery to user 101 and/or community 102. For example, interactive database 130 may include processed, extracted, and/or otherwise readily-accessible or real-time data for retrieval by access network 120 and deliverable to users 101 and/or community 102 with minimal querying, processing, and/or bandwidth.

Access network 120 is connected to an analytics engine 140 that can strategically handle large volumes of data while producing real-time and fast batch-produced results. For example, analytics engine 140 may include one or more databases 160 in a cluster that store various forms of automotive data, and data from access network 120 can be delivered and retrieved to and from databases 160. As shown in FIG. 1, multiple databases 160 can be used in order to more effectively manage exceedingly large and different types of automotive data sets. For example, database 160 may be a Big Data system capable of storing and managing extremely large data sets from several sources and having several different associations and attributes between entries. As used herein, Big Data is defined as an extremely-high capacity distributed storage and analysis system, including those found in U.S. Pat. No. 8,195,712 to McCormick and the Aug. 29, 2012 article “The Data Era—Moving from Big Data 1.0 to Big Data 2.0” by Kaskade in the Cloud Computing Journal, all of which are incorporated by reference herein in their entirety. An analytics engine 140 may include all or relatively large amounts of raw or unprocessed automotive data stored in databases 160 from entry by users 101 and/or collection from community resources 102.

Analytics engine 140 further includes a processor 150 that coordinates, analyzes, and/or creates data using database 160 and/or input data from access network 120. Such analyses may be in useable form and stored in interactive database 130. Processor 150 may further provide a number of data management functions to analytics engine 140. For example, processor 150 may perform real-time analysis on input streams of automotive data received from access network 120. Such real-time analysis may provide instantly-useable excerpts from received data, or predictive or suggestion-type data, storable on interactive database 130 for relatively immediate consumption by users 101 and/or community 102. Processor 150 may perform such real-time analysis at desired interval points and/or for known types of inputs and outputs so as to incrementally build or supplement a real-time distributed analysis stored on analytics database 160 and/or interactive database 130, for example.

Processor 150 may also store data input from access network 120 into database 160. In this way all data useable in analytics may be moved to database 160 in a useable format to create a near-universal data set, while interactive database 130 may be curated with only data ready for real-time delivery. Processor 150 may further perform specific suggestive analysis, analytics, forecasting, and/or machine learning on the contents of database 160 and data input from users 101 and community 102 via access network 120. These processes may use Big Data storage and leveraging methods on data in databases 160. For example, processor 150 may retrieve and process data from databases 160 in batches or in response to specific requests and provide useable results to access network 120 for storage in interactive database 130. Processor 150 may further coordinate processes from databases 160, which may be performed in batches or other times long after data storage in databases 160, with real-time analysis performed on incoming data from access network 120. Resulting outputs may be merged, correlated, or otherwise combined for useable results provided to access network 120 and storable on interactive database 130, accessible for immediate querying. For example, processor 150 may compare underlying data for both a real-time and universal analysis and merge the real-time analysis into the most recent batch results of the universal analysis if new data was used in the real-time analysis over the batch analysis.

Processor 150 may include several processors, machine clusters, and/or high-efficiency distributed network members with sufficient speeds and handling capacities to enable and work with Big Data methods. Processor 150 may be pre-programmed or be configurable based on desired analysis, including with instruction or requests from access database 120 with feedback as to what types of analytics or data storage preferences between multiple databases should be executed. Further, processor 150 may configure itself through machine learning based on received data and inquiries that may suggest desired or related predictive analysis available through such data.

Although analytics engine 140 and access network 120 are shown in FIG. 1 as individual systems with subcomponents, it is understood that these elements may be co-located in a single device having adequately differentiated file systems and processing configurations. Alternatively, the elements shown in FIG. 1 may be remote and plural, each communicatively connected at adequate speeds to provide necessary data transfer and analysis, if, for example, more resources or better logistics are available in distinct locations. For example, analytics engine 140 may be a distributed file system across several individual storage devices, and/or processor 150 may be similarly distributed across several high-efficiency clusters.

Example embodiment automotive tracking and analysis system 100 can be used in several ways to provide meaningful automotive information to users. As shown in FIG. 1, user 101 can provide user automotive data 201 to access network 120. For example, a user 101 can log in over the Internet or other network and authenticate to access network 120, or anonymous communication between user 101 and access network 120 can be provided.

Users 101 can provide a large variety of user automotive data 201 to access network 120, including vehicular, location, or environmental data, for example, in the form of queries or input. For example, user automotive data 201 can include vehicular information including vehicle license plate, color, make, model, condition, behavior, incident involvement, location, VIN, etc. Or, for example, automotive data 201 can include geo-location or geo-coded input, road conditions, traffic flow and conditions, weather, police enforcement, mile marker or road sign condition or presence, etc. Automotive data 201 can be formatted as informational input, such as a simple user location or report of a missing road sign, or user automotive data 201 can be input as a query, such as an inquiry as to traffic at a particular position or history of an encountered vehicle.

Example system 100 is configured to in real-time receive and manage huge amounts of user automotive data 201, both real-time and historical. As such, several users 101 may each provide user automotive data 201 at very fine levels. Users 101 can run an application that easily and safely captures automotive data 201 for input into access network 120 to encourage fine levels of input. For example, an application interface for user 101 may permit user 101 to capture an image of a road condition and easily tag it under a general category like “hazard” or “heavy traffic” or “incorrect road sign” and automatically geocode the image or provide other context information for the image and provide all image and input data to access network 120. Or user 101 may speak a license plate number for a vehicle driving erratically and also speak the erratic behavior, and an application for user 101 may translate such speech into text, with automatic context information addition, for transmission to access network 120 as automotive data 201. Or, for example, user 101 may set or program a device to automatically report conditions like location, movement, signal strength, phone usage, etc. that requires no additional human interaction in order to report the same as user automotive data 201 to access network 120.

If user 101 is in a mobile situation, automatic and simplified input may aid in increased and safer user automotive information gathering and reporting. Similarly, if user 101 is in a non-mobile and safer situation, such as at a computer terminal in a library or on a smartphone while waiting for an appointment, user 101 may be configured to provide a more involved interface that gathers more automotive data, such as a detailed description of a road problem or driver erratic behavior. User automotive data 201 provided in example system 100 can be real-time data or historical data input post-hoc.

Access network 120 provides automotive data 201 to analytics engine 140 as a real-time input stream 230 compatible with analytics engine 140, storage on databases 160, and/or analysis with processor 150. Access network 120 may provide some degree of formatting to user automotive data 201 before providing stream 230, such formatting based on type and content. Additionally, user automotive data 201 may possess some uniformity or other desired formatting by user 101. For example, user 101 may include a processor that is specifically configured to transmit input information in a specific format with automatically-included and formatted geocoding including time and location. Also, for example, access network 120 may perform some post-processing on received data 201, such as image analysis of an input image to extract a car make and model and/or license plate number. Any and all such formatted data can be provided through stream 230 to analytics engine 140.

Analytics engine 140 can provide a wide variety of calculations, routines, analytics, etc. on database 160 with processor 150 and provide the results 240 to access network 120, which can in real-time interact with and fetch a manageable data set. Moreover, analytics engine 140 can conduct such analyses at specific intervals or other times based on resource availability and/or data completeness. As discussed above, results 240 can include any analysis of data from database 160 and/or real-time data from stream 230 that may require no additional storage before being processed and merged into results 240. Storage of comprehensive amounts of fine automotive data in databases 160 may not interfere with analysis and creation of results 240 for access network 120 through Big Data management and proper resource outlaying to processor 150.

Because databases 160 can store comprehensive and extensive automotive data, both individual- and aggregate-type automotive data from both real-time and historical input, whereas interactive database 130 may store more compact results 240 for rapid, real-time access, processor 150 can perform any type or number of requested, programmed, and/or desired analysis as an ongoing or batch-type background process so as to provide smaller, accessible results 240 to access network 120. An endless number of analyses are possible with appropriate programming of analytics engine 140, including previously-installed algorithms, analyses developed through machine learning, and routines input on the fly. For example, analytics engine 140 may perform data associations or perform analysis based on user inquiries, data entry 201, and/or other machine learning. More user inquiries or entries regarding or relevant to a particular type of analysis may result in analytics engine 140 performing batches of corresponding analyses in a distributed manner.

An example analysis may include analytics engine 140 coupling multiple tuples of datasets in database 160, such as accident report and location, or erratic driving incident and car type, to calculate a recommendation and/or prediction relating to such data. Another example analysis may include analytics engine 140 performing historical regression on traffic density at a particularly-requested location verses date to produce predicted heavy traffic times/days at the position. Another example analysis may include analytics engine 140 comparing data of a particular data entry against other verified sources to determine the accuracy of particular automotive data. Another example analysis may include analytics engine 140 compiling vehicle and location data, including vehicle damage or history, for example, on a single vehicle, identified by appearance, registration, VIN, license plate, etc., into a single report or safety metric for that vehicle. Another example analysis may include analytics engine 140 correlating a road condition, such as a broken traffic signal or pothole, with a specific location and providing a map where such hazards exist. Another example analysis may include analytics engine 150 determining a number of similar inputs and their frequency, identifying a shared rationale or keyword for the report, and determining popular or urgent automotive issues based on the frequency and shared rationales.

As seen, because of the fine granularity of data input from users 101 and storable in database 160, which can be a Big Data system specifically configured to handle large amounts of diverse data, an infinite variety of different comparisons, collections, analyses, predictions, etc. may be made by analytics engine 140. Operators may program analytics engine 140 to provide any desired type of analysis through appropriate machine learning configurations.

Results 240 provided by analytics engine 140 may compact, real-time, and/or ready for user consumption, such as in the form of a prediction or recommendation. Analytics engine 140 may provide results 240 in regular batches and/or in real-time to access network 120 in a format for fast delivery, such as events and automotive issues graphed by map, simple issue alerts, separated string fields listing all associations for a particular category/vehicle, etc. Results 240 may additionally be stored on analytics engine 140 for additional analysis, machine learning, and/or backup.

Community 102 may then access results 206 on access network 120 in real-time, based on request or otherwise as desired. Community 102 may be connected to access network 120 in much the same way as users 101, such as through a login through the Internet, or through conventional report delivery from a paid subscription service, for example. Delivered results 206 may be delivered nearly instantly in response to a query. Delivered results 206 may further be delivered based on relevance to characteristics of community 102. Although user 101 and community 102 are shown as separate entities in FIG. 1 for purposes of input 201, it is understood that users 101 may become a part of community 102 and vice versa. For example, delivered results 206 may be a recommendation, prediction, or other real-time analysis particularly relevant or associated with a user 101 based on their input automotive data 201, in which case user 101 can be a part of community 102 consuming delivered results 206.

### Example Methods

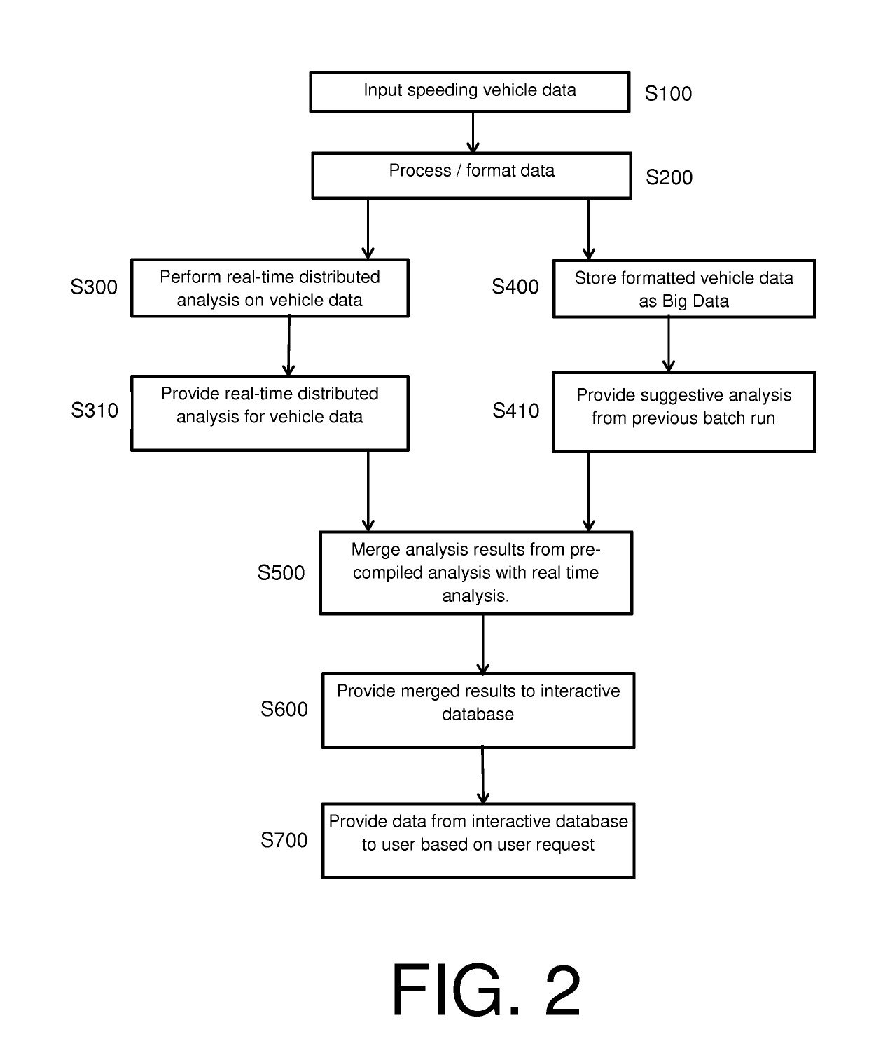

Example system 100 being described with several example configurations, example methods are now described that are uniquely enabled by example systems. As shown in FIG. 2, a user, such as a mobile device user with a smartphone loaded with an automotive data application configured in accordance with example embodiments, inputs data about a speeding vehicle in S100. The input may be in the form of a query about the vehicle, a picture taken of the vehicle as it sped by, an input later describing the vehicle speed and location, etc. Input in S100 may require very little or no user attention and/or interaction, such that input S100 can be repeated in example methods for very small pieces of information and without distracting a mobile user needing to concentrate on driving.

In S200, the input data is formatted for compatibility, enhancement, and/or addition of data. For example, the picture taken by the user can be analyzed by image processing software or programs on the user's device or on an access network receiving the image to determine car make, model, color, speed, license plate number, etc., geocoded with location and date, associated with the particular user, etc. The processing in S200 may thus add additional information to the basic input with little or no further user interaction. Additionally, a user may be able to add additional meta or context data in S200, such as mark the car as “speeding” or “erratic driver” or input visual characteristics of the car.

In S300 the analytics engine receives the formatted data from the access network and may perform any applicable real-time distributed analysis on this relatively smaller data stream. In S400, the received data may be concurrently stored in an analytics database for batch-type larger-scale analysis. Analysis on an analytics database, such as a Big Data Cluster, can be on-going throughout an incoming data stream and storage and/or real-time analysis of the same without interruption. S300 and S310 may be skipped if no applicable real-time analysis is available for a particular portion of input; similarly, S400 and S410 may be skipped if data does not require analytics or storage in an analytics database, such as if the data is fully redundant with previous data.

In S310, results of the real-time analysis in S300 are provided. The results can be any analysis or excerpted data; for example data of the vehicle being pulled over and ticketed may be analyzed and passed on instantly in S310. In S410, any available and relevant existing results from analytics on a Big Data database may also be identified and provided. The results can be a suggestive or predictive analysis; for example, formatted geo-coded speeding received from S200 may be associated with an existing record for the identified vehicle in a Big Data database that is drawn from prior user or community input, including public vehicle registrations, prior user complaints, ticket citation information, etc. Or, for example, the received speeding information and other relevant input details may be compared across different car makes and models, associated with time of day and used in predictive road danger assessment, etc., stored in a Big Data database in an analytics engine, based on analytical need and programming.

In S500, the real-time and batch analytics data can be merged in a meaningful way if both were provided. Real-time data and results based thereon calculated in S400 may represent an update to Big Data computations provided in S410, and a merge of the two in S500 can provide a more complete and up-to-date result. For example, the stop and ticketing information passed through in S310 may be combined with a compiled report from S410 of incidents for that vehicle in S500. A user providing the initial speeding data may thus have a real-time and comprehensive analysis based on the data provided. Merged results from S500 may be stored in the analytics database as well, and any results from S310 can then be discarded.

In S600 merged information from S500 may be formatted and provided to an access network. Users or community resources can be provided results from interacting database instantaneously in S700. For example, a user inputting a speeding picture in S100 may be provided with results in S700 about whether the car was ever ticketed for speeding. This information can be provided to the user in S700 as the result of a pre-compiled analytical association from S410, and/or as a real-time report of the vehicle being subsequently pulled over from another user input in S310. In this way, example systems and methods can intake huge amounts of automotive data from a variety of sources and deliver real time responses to user requests.

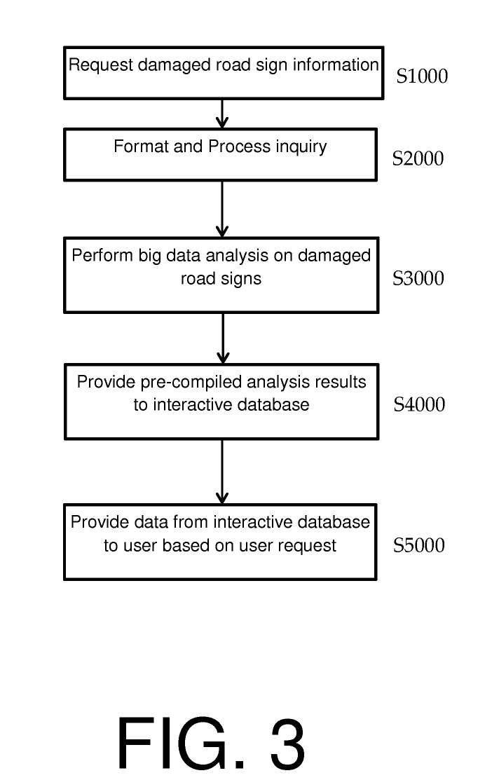

FIG. 3 is an illustration of another example method. As shown in FIG. 3, user input in the form of a request is received in S1000 by an example embodiment system. The request may be from a community service, such as a Department of Transportation database or official determining road repairs, about missing or damaged road signs in a particular area/route, for example. In S2000, the request can be formatted in a way that provides compatibility and best request servicing impression for the requestor and processed by the access network. The access network may compare the request against an interactive database to see if any responsive data is available in real time in S2000.

In S3000, a background process may run at regular intervals in batches for analysis of Big Data in an analytics engine. For example, the process may invoke machine learning that provides suggestive analysis on automotive data, responsive to requests for particular data or analyses. This process may regularly compile results at desired intervals and provide the same to an interactive database for real-time fetching and faster reads in S4000.

In S5000, the results of the analysis, which may include, for example geocoded road sign damage or absence from collection and analysis of user inputs, online map markers, government records, etc., are provided to the requestor form the interactive database. It is understood that S3000 and S4000 may be executed independently of each other depending on big data batches run at desired times or in response to particular inputs or operator commands determined by an example embodiment access network itself based on user inquiries and/or frequency.

Example methods and embodiments thus being described, it will be appreciated by one skilled in the art that example embodiments may be varied through routine experimentation and without further inventive activity. For example, although a first and second network are shown dividing analytical and reception/providing tasks to manage large streams of automotive data, it is understood that multiple additional networks, hardware components, and/or users can perform desired analyses and task-division in example embodiments. Variations are not to be regarded as departure from the spirit and scope of the exemplary embodiments, and all such modifications as would be obvious to one skilled in the art are intended to be included within the scope of the following claims.

What is claimed is:

1. A system for automotive data analysis, the system comprising:
a first network configured to receive automotive data from a plurality of users, wherein the first network includes a first database; and
a second network connected to the first network, wherein the second network includes,
at least one second database sized and otherwise configured to store the automotive data from the plurality of users, and
a processor configured to,
analyze the automotive data from the first network before the automotive data is stored on the second database so as to generate real-time automotive analysis,
store the automotive data in the second database so as to generate a universal automotive data set,
analyze the universal automotive data set so as to generate a universal automotive analysis, and
provide the real-time automotive analysis and the universal automotive analysis to the first database.

2. The system of claim 1, wherein the first network includes at least a first network processor configured to format the automotive data and provide the formatted automotive data to the processor of the second network.

3. The system of claim 1, wherein the plurality of users are mobile stations, and wherein the first network is configured to receive the automotive data from the mobile stations.

4. The system of claim 1, wherein the first network is further configured to provide the real-time automotive analysis and the universal automotive analysis from the first database to users and community.

5. The system of claim 1, wherein the first network is an access network configured for receiving automotive data and delivering real-time and universal automotive analysis to a plurality of users and community.

6. The system of claim 5, wherein the second network is a Big Data analytics engine configured to store the automotive data, and wherein the second database is larger than the first database.

7. The system of claim 1, wherein the processor is further configured to merge the real-time and the universal automotive analyses based on a comparison of underlying data of the two and to provide the merged analyses to the second network.

8. The system of claim 1, wherein the automotive data includes user or third-party input of at least one of vehicle information, traffic conditions, and road conditions, and traffic incidents.

9. The system of claim 8, wherein the first network is configured to add at least one of vehicle information and location information to the automotive data, and wherein the universal automotive analysis is a predictive analysis.

10. The system of claim 1, wherein the processor is further configured to generate a plurality of the universal automotive analyses in batches.

11. The system of claim 10, wherein the plurality of the universal automotive analyses are selected based on machine learning of the automotive data received from users.

12. A method of managing automotive data and analysis, the method comprising:
receiving automotive data from a plurality of users at first network including a first database;
analyzing, with a processor in a second network, the automotive data from the first network;
storing the automotive data so as to generate a universal automotive data set in a second database in the second network based on the analyzing the automotive data;
analyzing, with the processor, the universal automotive data set so as to generate universal automotive analysis;
storing the universal automotive analysis in the first database; and
providing the universal automotive analysis to the users or community from the first database.

13. The method of claim 12, further comprising:
generating, with the processor, a real-time automotive analysis based on the analyzing the automotive data and before the storing the automotive data.

14. The method of claim 13, wherein the analyzing the universal automotive data set is performed repetitively and in batches, and wherein the analyzing the universal automotive data set and the generating the real-time automotive analysis are performed simultaneously.

15. The method of claim 13, further comprising:
comparing the automotive data used in real-time automotive analysis and in the universal automotive analysis; and
merging the real-time automotive analysis and the universal automotive analysis based on the comparing.

16. The method of claim 12, wherein the automotive data includes user or third-party input of at least one of vehicle information, traffic conditions, and road conditions, and traffic incidents.

17. The method of claim 12, further comprising:
formatting and analyzing, by the first network, the automotive data to add at least one of vehicle information and location information to the automotive data, wherein the formatting and analyzing are executed prior to the analyzing, with the processor in the second network, the automotive data.

18. The method of claim 12, wherein the analyzing the universal automotive data set includes conducting analyses based on machine learning of the automotive data received from users, the method further comprising:
storing the universal automotive analysis on the second database.

19. The method of claim 12, wherein the universal automotive analysis is a predictive analysis, and wherein the providing the universal automotive analysis to the users or community is executed based on the received automotive data.

20. A system for automotive data analysis, the system comprising:
a network including a first file system storing automotive analysis and configured for user access; and
an analytics engine connected to the network, wherein the analytics engine includes,
at least one second file system that is larger than the first file system and is configured to store automotive data from which the automotive analysis is generated and the automotive analysis, and
a processor configured to analyze the automotive data set so as to generate the automotive analysis, to move automotive data into the second file system from the first network and to move the automotive analysis to the first file system.
